(19) United States
(12) Patent Application Publication
(10) Pub. No.: US 2026/0107116 A1
(43) Pub. Date: Apr. 16, 2026

(54) EFFICIENT TWO-STEP SENSING MECHANISM

(71) Applicant: LENOVO (BEIJING) LIMITED, Beijing (CN)

(72) Inventors: Haiyan Luo, Shanghai (CN); Yinghui He, Hangzhou (CN); Guanding Yu, Hangzhou (CN); Tingfang Tang, Beijing (CN)

(21) Appl. No.: 19/113,334

(22) PCT Filed: Oct. 28, 2022
(86) PCT No.: PCT/CN2022/128292

§ 371 Date: Mar. 19, 2025

(51) Int. Cl. H04W 4/38; H04L 27/26; H04W 48/20

(52) U.S. Cl. CPC H04W 4/38; H04L 27/26025; H04W 48/20

(57) ABSTRACT

A method (600) and an apparatus for two-step sensing mechanism are disclosed. A sensing function (SF) comprises a processor and a transceiver coupled to the processor, wherein the processor is configured to receive, from a first network node, via the transceiver, a first sensing service request (602); and transmit, to a second network node or a UE, via the transceiver, a second sensing service request, wherein the second sensing service request includes at least a first sampling rate and a second sampling rate that is higher than the first sampling rate (604).

### FIELD

The subject matter disclosed herein generally relates to wireless communications, and more particularly relates to efficient two-step sensing mechanism.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Artificial Intelligence (AI), Integrated sensing and communication (ISAC), signal-to-noise ratio (SNR), Application Function (AF), Network Exposure Function (NEF), Unified Data Management (UDM), Access and Mobility Management Function (AMF), Location Management Function (LMF), LTE Positioning Protocol (LPP), Gateway Mobile Location Centre (GMLC), Radio Access Network (RAN), Network Repository Function (NRF), Sensing Function (SF), SF-Control Plane (SF-C), SF-User Plane (SF-U), Operation, Administration and Management (OAM), Convolutional Neural Network (CNN), Unmanned Aerial Vehicle (UAV), Vehicle to Everything (V2X).

The development of next-generation wireless communication systems is not limited to seeking high data rate and low communication latency, but also tends to be intelligentialized with the help of Artificial Intelligence (AI) technique. Toward this end, there are three necessities: sensing data for supporting AI algorithms, communication for information delivery, and computation ability for implementing AI algorithms. Therefore, 6G systems are expected to be the unity of mobile communication networks, sensing networks, and compute first networking. Integrated sensing and communication (ISAC) is proposed as one of the critical techniques in 6G systems. ISAC aims to achieve sensing function and communication function with shared hardware simultaneously.

Different sensing applications have different sensing requirements. Some sensing application may perform per-object sensing function for an object. For example, a regulator needs to perform continuous tracking of suspicious vehicles or Unmanned Aerial Vehicles (UAVs). Some sensing application may perform per-area sensing function towards a sensing area. For instance, the UAV regulation at civil aviation airports requires performing sensing function towards specific wide-area airspace to identify illegal UAVs. Dynamic map application for Vehicle to Everything (V2X) requires performing real-time sensing function towards the whole road to update map for driver assistance system. A real-time sensing function towards the whole room is required in a smart home for recognizing action of sensing target. The sensing can be performed by a base station (e.g., gNB) or by a UE.

Taking the action recognition task as an example, gNB needs to continuously transmit sensing signals towards the sensing area at a given sampling rate. Generally, sampling rate is closely related with recognition accuracy and other factors. For example, to achieve recognition accuracy of 90%, the sampling rate should be 400 Hz.

This invention targets improvement of the sensing mechanism.

### BRIEF SUMMARY

Method and apparatus for two-step sensing mechanism are disclosed.

In one embodiment, an sensing function (SF) comprises a processor and a transceiver coupled to the processor, wherein the processor is configured to receive, from a first network node, via the transceiver, a first sensing service request; and transmit, to a second network node or a UE, via the transceiver, a second sensing service request, wherein, the second sensing service request includes at least a first sampling rate and a second sampling rate that is higher than the first sampling rate.

In some embodiment, if the second network node is a RAN node, the processor is further configured to select the RAN node according to at least sensing frequency information and sensing waveform information included in the first sensing service request. In some embodiment, the second sensing service request further includes a threshold, and the processor is further configured to receive, from the selected RAN node, via the transceiver, a sensing response, wherein, the sensing response is: no sensing target, or raw sensing data or sensing result based on the second sampling rate.

In some embodiment, if the second sensing service request is transmitted to the UE, the processor is further configured to determine multiple tuples, where each tuple is associated with one energy status of UE and includes at least the first sampling rate and the second sampling rate. In some embodiment, the processor is further configured to select the UE based on at least sensing area information included in the first sensing service request. In some embodiment, the processor is configured to transmit, to the UE, via the transceiver, the multiple tuples, and the processor is further configured to receive, from the UE, via the transceiver, a sensing response, wherein the sensing response is: no sensing target, or raw sensing data or sensing result based on the second sampling rate. In some embodiment, the processor is further configured to select a RAN node associated with the UE based on at least sensing area information included in the first sensing service request. In addition, the processor is configured to transmit, to the selected RAN node, via the transceiver, the multiple tuples, and the processor is further configured to receive, from the UE selected by the selected RAN node, via the transceiver, a sensing response, wherein the sensing response is: no sensing target, or raw sensing data or sensing result based on the second sampling rate.

In some embodiment, the processor is further configured to determine the first sampling rate and the second sampling rate according to sensing requirement included in the first sensing service request.

In some embodiment, the processor is further configured to determine sensing frequency and sensing waveform based on sensing type included in the first sensing service request.

In another embodiment, a RAN node comprises a processor and a transceiver coupled to the processor, wherein the processor is configured to receive, from a sensing function (SF), via the transceiver, a first sensing service request including multiple tuples, where each tuple includes at least a first sampling rate and a second sampling rate that is higher than the first sampling rate; and determine a tuple from the multiple tuples for a UE according to energy status of the UE.

In some embodiment, the processor is further configured to send, to the UE, via the transceiver, a second sensing service request including at least the determined tuple.

In yet another embodiment, a UE comprises a transceiver; and a processor coupled to the transceiver, wherein the processor is configured to receive, from a network node, via the transceiver, a sensing service request including at least one tuple, where each tuple includes at least a first sampling rate and a second sampling rate that is higher than the first sampling rate; perform a sensing based on the first sampling rate; determine a sensing factor according to the sensing based on the first sampling rate; compare the sensing factor with a threshold; perform a sensing based on the second sampling rate if the sensing factor is higher than the threshold; and report, to a sensing function (SF), via the transceiver, a sensing response, wherein the sensing response is no sensing target if the sensing factor is lower than the threshold, and is sensing data or sensing result based on the second sampling rate if the sensing factor is higher than the threshold.

In some embodiment, the first sensing service request includes one tuple including at least the first sampling rate and the second sampling rate.

In some embodiment, the first sensing service request includes multiple tuples each including at least the first sampling rate and the second sampling rate associated with an energy status of UE, and the processor is further configured to select one tuple from the multiple tuples according to energy status of the UE.

In further embodiment, a method performed at an SF comprises receiving, from a first network node, a first sensing service request; and transmitting, to a second network node or a UE, a second sensing service request, wherein, the second sensing service request includes at least a first sampling rate and a second sampling rate that is higher than the first sampling rate.

In further embodiment, a method performed at a RAN node comprises receiving, from a sensing function (SF), a first sensing service request including multiple tuples, where each tuple includes at least a first sampling rate and a second sampling rate that is higher than the first sampling rate; and determine a tuple from the multiple tuples for a UE according to energy status of the UE.

In further embodiment, a method performed at a UE comprises receiving, from a network node, a sensing service request including at least one tuple, where each tuple includes at least a first sampling rate and a second sampling rate that is higher than the first sampling rate; performing a sensing based on the first sampling rate; determining a sensing factor according to the sensing based on the first sampling rate; comparing the sensing factor with a threshold; performing a sensing based on the second sampling rate if the sensing factor is higher than the threshold; and reporting, to a sensing function (SF), a sensing response, wherein the sensing response is no sensing target if the sensing factor is lower than the threshold, and is sensing data or sensing result based on the second sampling rate if the sensing factor is higher than the threshold.

### BRIEF DESCRIPTION OF THE DRAWINGS

A more particular description of the embodiments briefly described above will be rendered by referring to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of gNB based sensing;

FIG. 2 illustrates a first sub-embodiment of the first embodiment;

FIG. 3 illustrates a second sub-embodiment of the first embodiment;

FIG. 4 illustrates a first sub-embodiment of a second embodiment;

FIG. 5 illustrates a second sub-embodiment of the second embodiment;

FIG. 6 is a schematic flow chart diagram illustrating an embodiment of a method;

FIG. 7 is a schematic flow chart diagram illustrating another embodiment of a method;

FIG. 8 is a schematic flow chart diagram illustrating a further embodiment of a method;

FIG. 9 is a schematic flow chart diagram illustrating a yet another embodiment of a method; and

FIG. 10 is a schematic block diagram illustrating another apparatus according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the”also refer to “one or more”unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As described in the background part, when sensing is performed, a sampling rate is configured. In some scenarios (e.g., smart home scenario), the sensing target might be static for an extended period, or even there may be no sensing target. If there is no sensing target in the sensing area, a high sampling rate (e.g., 400 Hz) would result in high waste of communication resources. It may be desirable to configure a low sampling rate. However, when there is sensing target in the sensing area, the high sampling rate is necessary.

In view of the above, this disclosure proposes a two-step sensing mechanism. For example, in a first step, a low sampling rate is used to detect the existence of the sensing target. A sensing factor, e.g., sensing signal-to-noise ratio (SNR), calculated based on the low sampling rate (in particular, based on the sampled signals that are obtained according to the low sampling rate) is compared with a configured or predetermined threshold. If the sensing factor is lower than the threshold, it is determined that there is no sensing target and the sensing procedure ends. For example, to achieve a miss rate lower than 1%, the low sampling rate in the first step can be set as 50 Hz and a threshold can be configured as 10 dB. Otherwise (e.g., the sensing factor is higher than the threshold), a second step is needed where a high sampling rate (e.g., 400 Hz) is used to perform a specific sensing service, e.g., motion recognition. Since the resource cost of the first step is much lower than that of the second step, the average resource cost for a sensing task is lower than that of the conventional method in which only one sampling rate (e.g., high sampling rate) is configured (it is equivalent to directly performing the second step).

Detailed embodiments are described below.

The sensing can be performed by a base station (e.g., gNB or RAN node) or by a UE. It means that the sensing can be generally divided into gNB based sensing and UE based sensing. In the following description, the base station is represented by gNB. Incidentally, gNB is denoted as ‘RAN node’ in the Drawings. The two-step sensing mechanism can be applied for both gNB based sensing and UE based sensing.

A first embodiment relates to two-step sensing mechanism in gNB based sensing.

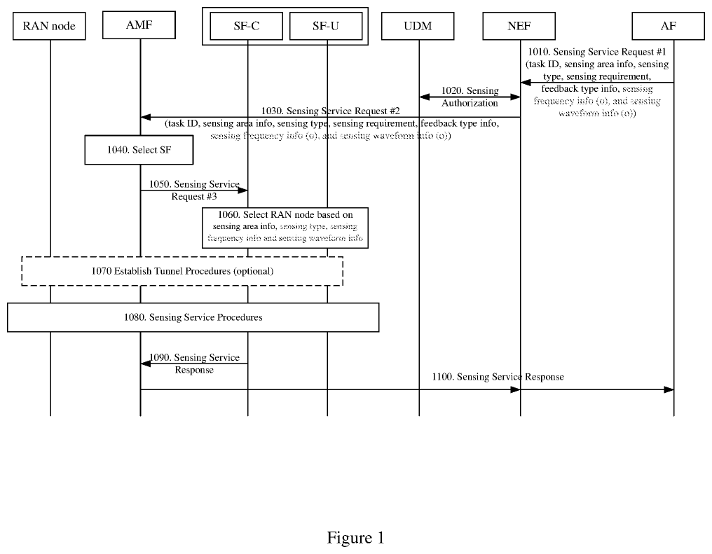

Before describing the two-step sensing mechanism in gNB based sensing, a gNB based sensing procedure is described with reference to FIG. 1.

In step 1010, AF transmits to NEF a sensing service request #1. The sensing service request #1 includes task ID that is used to identify different tasks, sensing area info (e.g., center point coordinates and the radius or the length and width), sensing type (e.g., motion recognition task, dynamic map, vehicle velocity measurement, vehicle tracking, emergency notification, vehicle audit, etc), sensing requirement (e.g., sensing accuracy, miss rate, sensing resolution, duration, delay, etc), and feedback type info (e.g., raw sensing data that is received at gNB without further processing, or sensing result that is the motion type of a sensing target for a motion recognition task). The sensing service request #1 optionally further includes sensing frequency info, and sensing waveform info.

For a same sensing task, different frequencies and/or different waveforms have different effects. If the sensing frequency info and the sensing waveform info are included in the sensing service request, they are chosen by the sensing consumer (e.g., a UE or AF) for a specific sensing service. For example, for a short-distance sensing application, sensing signals working in high frequency, e.g., mmWave, is better since high-frequency signals can achieve a better resolution. For a long-distance sensing application, sensing signals worked in low-frequency, e.g., sub-6 GHz (i.e., frequency that is lower than 6 GHZ), is better since high-frequency signals suffer a lower attenuation.

In step 1020, NEF checks the sensing service request (i.e., the sensing service request #1) from AF for authorization. The authorization information can be stored locally in NEF. Alternatively, the authorization information is stored in UDM while NEF requests the UDM for authorization verification.

In step 1030, if the authorization is verified, NEF selects an appropriate AMF (e.g., based on sensing area info) and sends a sensing service request #2 to AMF. The sensing service request #2 includes the same parameters as the sensing service request #1.

If LMF and SF are co-located, steps 1020 and 1030 can be performed in an alternative manner. That is, GMLC is inserted between NEF and AMF. In step 1020, NEF forwards the sensing service request (e.g., sensing service request #1) to GMLC. GMLC requests UDM for authorization verification. In step 1030, if the authorization is verified, GMLC selects suitable AMF (e.g., based on sensing area info), sends a sensing service request #2 (that includes the same parameters as the sensing service request #1) to the selected AMF.

Alternatively to steps 1010, 1020 and 1030, if the sensing service request is sent by a UE (i.e., the sensing service is triggered by the UE), the sensing service request is sent from the UE via RAN node to AMF.

In step 1040, AMF selects SF according to at least the sensing area info, e.g., according to the sensing area info and optionally the sensing type and further optionally the sensing requirement. The sensing area info, the sensing type and the sensing requirement are included in the sensing service request (e.g., sensing service request #2) received by AMF. It is assumed that each SF corresponds to a serving area and each SF has registered its serving area and optionally supported sensing type(s) and further optionally supported sensing requirements with NRF. Accordingly, AMF is able to select SF based on at least the sensing area info included in sensing service request #2 by referring to NRF.

Incidentally, SF-C stands for SF control plane and SF-U stands for SF user plane. SF refers to both SF-C and SF-U. SF-C and SF-U can be alternatively one integrated SF.

In step 1050, AMF sends a sensing service request #3 to the selected SF (e.g., SF-C). The sensing service request #3 includes the same parameters as the sensing service request #2 (or the sensing service request #1).

Alternatively to steps 1030, 1040 and 1050, NEF can directly select SF according to the sensing area info by referring to NRF, and the sensing service request #2 is directly sent to the selected SF.

In step 1060, SF selects RAN node according to at least one of the sensing area info, the sensing type, the sensing frequency info and the sensing waveform info. For example, the RAN node is selected according to the sensing frequency info and the sensing waveform info. As mentioned earlier, the sensing frequency info and the sensing waveform info are optionally included in the sensing service request #3 (or the sensing service request #2 or the sensing service request #1). If the sensing frequency info and the sensing waveform info are not included in the sensing service request #3, SF determines the sensing frequency info and the sensing waveform info based on sensing type included in the sensing service request #3.

SF can obtain the sensing area info, the sensing type, the sensing frequency, and the sensing waveform supported by each RAN node by one of the following two ways. 1) It can be achieved via previous configuration by OAM. For example, OAM has previously informed the SF of the sensing area info, the sensing type, the sensing frequency, and the sensing waveform supported by each RAN node. 2) RAN node reports supported sensing area info, sensing type, sensing frequency info, sensing waveform info, etc., to AMF when RAN node establishes a connection with AMF via N2 interface. Then, AMF offers RAN node ID, supported sensing area info, sensing type, sensing frequency info, sensing waveform, etc., to NRF when AMF registers with NRF. When SF receives the sensing service request (e.g., sensing service request #3 from AMF or sensing service request #2 directly from NEF), SF can obtain the RAN node ID and the corresponding sensing area info, the sensing type, the sensing frequency info and the sensing waveform info supported by each RAN node by referring to NRF, and then select a suitable RAN node based on the comparison of at least one of “the sensing area info and the sensing type included in the sensing service request, and the sensing frequency and the sensing waveform included in the sensing service request or determined by SF” with at least one of “the sensing area info, the sensing type, the sensing frequency info and the sensing waveform info supported by each RAN node”.

In step 1070, a tunnel is established to provide a data transfer channel between SF and RAN node. Step 1070 is optional. In means that the tunnel can be not established. In general, SF provides the tunnel information (e.g., IP address and Tunnel Endpoint Identifier) or notification target address (e.g., IP address and optionally port number) along with each sensing service request, which is associated with task ID. There may be an E2E new protocol layer between RAN and SF, e.g., NR Sensing Protocol annex for the user plane (NRSPa-U). The NRSPa-U layer may be conveyed over IP, UDP or GTP-U protocol layer.

In step 1080, SF triggers the sensing service procedure, which is related to the two-step sensing mechanism and will be described later.

In step 1090, if a sensing result is required in the feedback type, SF returns the sensing result (e.g., for a motion recognition, the sensing result is the motion type) to AMF. If raw sensing data is required in the feedback type, SF returns raw sensing data (e.g., raw sensing data that is received at gNB without further processing) to AMF.

In step 1100, AMF returns the sensing result or raw sensing data to AF via NEF. Alternatively, the sensing service response may be sent by SF directly to AF or via NEF to AF.

Incidentally, if the sensing service is triggered by the UE, AMF returns the sensing result or raw sensing data to the UE.

The two-step sensing mechanism (i.e., step 1080) is described in detail. The two-step sensing mechanism in gNB based sensing can be based on gNB or based on SF. It means that the two-step sensing mechanism in gNB based sensing can be divided into gNB based two-step sensing mechanism and SF based two-step sensing mechanism.

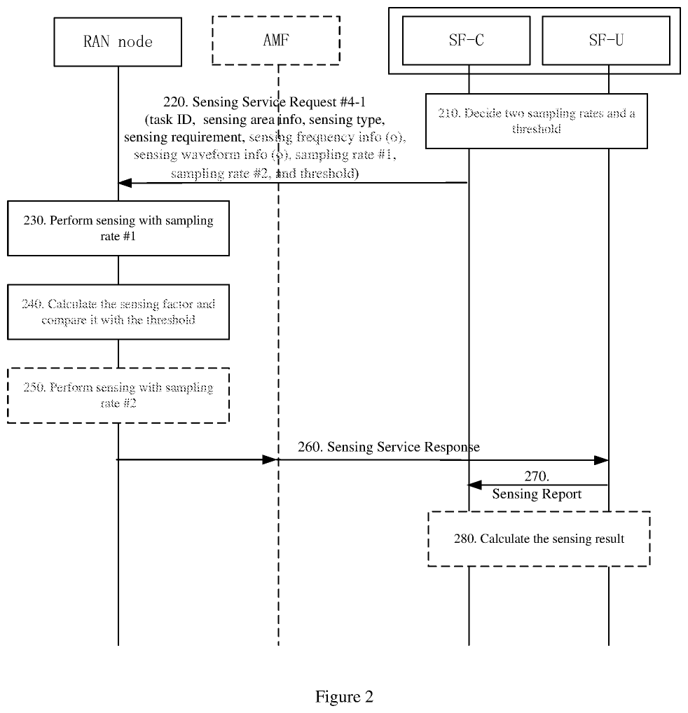

FIG. 2 illustrates a first sub-embodiment of the first embodiment, which relates to gNB based two-step sensing mechanism. Steps 210-280 in FIG. 2 are an implementation of step 1080.

In step 210, SF decides two sampling rates (e.g., sampling rate #1, sampling rate #2) and a threshold based on the sensing requirement (e.g., sensing accuracy and miss rate). Sampling rate #1 is lower than sampling rate #2 (or sampling rate #2 is higher than sampling rate #1). Sampling rate #1 can also be referred to as lower sampling rate, while sampling rate #2 can also be referred to as higher sampling rate. For example, sampling rate #2 (i.e., higher sampling rate) can be determined based on the sensing accuracy requirement and the sensing type since the accuracy is positively related to the higher sampling rate. Sampling rate #1 (i.e., lower sampling rate) and the threshold can be determined based on at least the miss rate, e.g., the miss rate and optionally the sensing type. For example, the lower the miss rate is, the higher the sampling rate #1 is determined and the lower the threshold is the determined.

In step 220, SF sends a sensing service request #4-1 to RAN node. The sensing service request #4-1 includes task ID, sensing area info, sensing type, sensing requirement, sensing frequency info (optional), sensing waveform info (optional), sampling rate #1, sampling rate #2 and the threshold. The RAN node is selected in step 1060.

In step 230, RAN node (e.g., gNB) performs sensing towards the given sensing area with the sampling rate #1 (i.e., lower sampling rate), the sensing frequency info and the sensing waveform info. Incidentally, if the sensing frequency info and the sensing waveform info are not included in the sensing service request #4-1, they are determined by the RAN node.

In step 240, RAN node calculates a sensing factor under the sampling rate #1 and compares the sensing factor with the threshold. For example, the sensing factor under sampling rate #1 can be a sensing SNR. If the sensing factor (e.g., sensing SNR) under the sampling rate #1 is lower than the threshold, it is determined that there is no sensing target in the sensing area, step 250 will not be performed. Otherwise (e.g., the sensing factor under the sampling rate #1 is equal to or higher than the threshold), step 250 will be performed.

In step 250, RAN node performs sensing towards the given sensing area with the sampling rate #2 (i.e., higher sampling rate), the sensing frequency info and the sensing waveform info.

In step 260, RAN node sends a sensing service response to SF-U based on the tunnel information or notification target address provided by SF. If step 250 is not performed, then the sensing service response is no sensing target in the sensing area. If step 250 is performed, then the sensing service response is raw sensing data sampling rate #2 (e.g., raw sensing data that is received at step 250 without further processing) or sensing result under sampling rate #2 (it means that RAN node calculates the sensing result based on the raw sensing data under sampling rate #2).

In step 270, SF-U informs SF-C that it has obtained the raw sensing data/sensing result under sampling rate #2 or no sensing target.

In step 280, if a sensing result is required in the feedback type and RAN node feeds raw sensing data to SF-U, SF (either SF-C or SF-U) calculates the sensing result (e.g., for a motion recognition task, the sensing result is the motion type) based on the raw sensing data under sampling rate #2 by using existing sensing algorithms, such pre-trained CNN model. If a sensing result is required in the feedback type and RAN node provides the sensing result to SF-U, SF provides the sensing result provided by the RAN node directly to sensing consumer (e.g., AF or UE). Otherwise (e.g., a sensing result is not required in the feedback type), there is no need to calculate the sensing result.

Incidentally, if there is only one integrated SF instead of SF-C and SF-U, steps 270 and 280 are performed internally within SF.

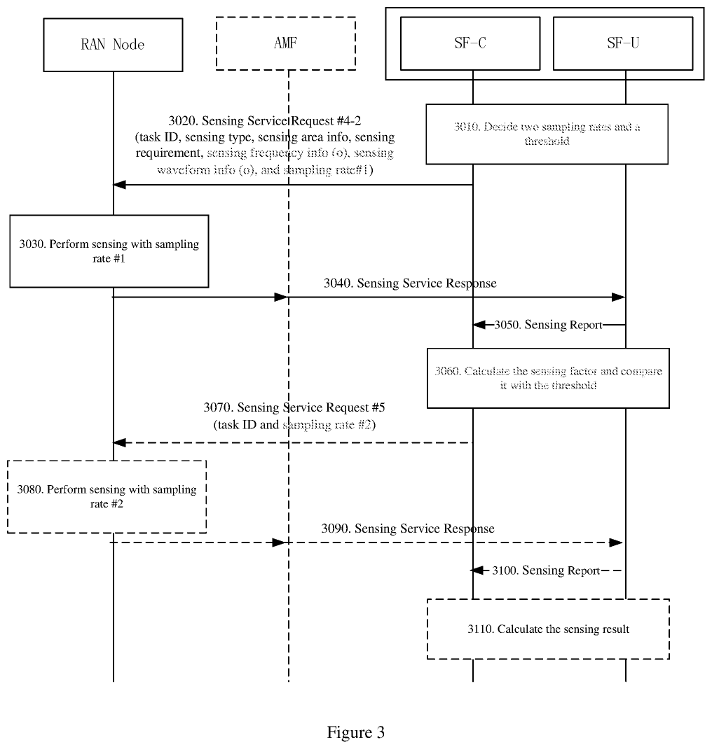

FIG. 3 illustrates a second sub-embodiment of the first embodiment, which relates to SF based two-step sensing mechanism. Steps 3010-3110 are an implementation of step 1080.

In gNB based two-step sensing mechanism described in the first sub-embodiment of the first embodiment, gNB is responsible to compare the sensing factor under the sampling rate #1 with the threshold to determine whether sensing with the sampling rate #2 is necessary to be performed. In SF based two-step sensing mechanism according to the second sub-embodiment of the first embodiment, SF is responsible to compare the sensing factor under the sampling rate #1 with the threshold.

Detailed description of the second sub-embodiment of the first embodiment is as follows:

Step 3010 is the same as step 210. In particular, in step 3010, SF decides two sampling rates (e.g., sampling rate #1 and sampling rate #2), and a threshold based on the sensing requirement (e.g., sensing accuracy and miss rate).

In step 3020, SF sends a sensing service request #4-2 to RAN node. The sensing service request #4-2 includes task ID, sensing type, sensing area info, sensing requirement, sensing frequency info (optional), sensing waveform info (optional) and sampling rate #1.

In step 3030, RAN node performs sensing towards the given sensing area with the sampling rate #1 (i.e., lower sampling rate), the sensing frequency info and the sensing waveform info. If the sensing frequency info and the sensing waveform info are not included in the sensing service request #4-2, they are determined by the RAN node.

In step 3040, RAN node sends a sensing service response (e.g., raw sensing data under sampling rate #1 that is received at gNB without further processing and optionally sensing factor) to SF-U based on the tunnel information or notification target address provided by SF.

In step 3050, SF-U informs SF-C that it has obtained the raw sensing data under sampling rate #1.

In step 3060, SF-U or SF-C calculates a sensing factor according to the raw sensing data under sampling rate #1 if the sensing factor is not received in step 3040 and compares the calculated sensing factor or the received sensing factor with the threshold. For example, the sensing factor can be the sensing SNR. If there is only one integrated SF instead of SF-C and SF-U, the raw sensing data is received by SF, and the sensing factor is calculated and compared with the threshold at SF.

If the sensing factor provided by RAN node directly or calculated according to the raw sensing data under sampling rate #1 is lower than the threshold, it is determined that there is no sensing target in the sensing area, and the sensing service procedure is over with no sensing target. Otherwise (e.g., the sensing factor provided by RAN node directly or calculated according to the raw sensing data under sampling rate #1 is equal to or higher than the threshold), the procedure continues with the following steps 3070 to 3110.

In step 3070, SF sends a sensing service request #5 to RAN node. The sensing service request #5 includes task ID and sampling rate #2.

In step 3080, RAN node performs sensing towards the given sensing area with sampling rate #2, the sensing frequency info, and the sensing waveform info associated with the same task ID (i.e., those contained in the sensing service request #4-2 or determined by RAN node).

In step 3090, RAN node sends raw sensing data or sensing result and optionally sensing factor under sampling rate #2 to SF-U.

In step 3100, SF-U informs SF-C that it has obtained the raw sensing data or the sensing result under sampling rate #2.

In step 3110, if a sensing result is required in the feedback type while the sensing result is not received in step 3090, SF calculates a sensing result (e.g., for a motion recognition task, the sensing result is the motion type) under sampling rate #2 based on the raw sensing data provided by RAN node by using existing sensing algorithms, such pre-trained CNN model. If raw sensing data is required in the feedback type, there is no need to calculate the sensing result.

If there is only one integrated SF instead of SF-C and SF-U, step 3050, 3060, 3100, and 3110 are performed internally within SF.

A second embodiment relates to two-step sensing mechanism in UE based sensing.

Before describing the two-step sensing mechanism in UE based sensing, a UE based sensing procedure is briefly described. The UE based sensing procedure is substantially the same as the gNB based sensing procedure described with reference to FIG. 1. The only difference is that, for UE based sensing, steps 1060 and 1070 are not necessary, and the step 1080 (i.e., two-step sensing mechanism) is implemented differently.

For UE based sensing, the sampling rate shall be closely related with energy status (e.g., battery level or power mode) of UE. Therefore, sensing consumer (e.g., AF) or SF may provide the high sampling rate, the low sampling rate and the threshold associated with a given energy status (e.g., battery level or power mode) of UE.

For example, a first tuple (i.e., first sampling rate #1, first sampling rate #2, and first threshold) is configured for a first energy status (e.g., first battery level or power mode, referred as power mode for simplicity), while a second tuple (i.e., second sampling rate #1, second sampling rate #2, and second threshold) is configured for a second energy status (e.g., a second power mode). Generally, a high power mode (i.e., UE's remaining battery is high) supports high sampling rate, which is more power consumptive. For example, if the first power mode is higher than the second power mode, the first sampling rate #1 can be higher than the second sampling rate #1; and/or the first sampling rate #2 can be higher than the second sampling rate #2. Optionally, the first threshold can be higher than the second threshold. For the single sampling rate case, a combination of (sampling rate, threshold) associated with the energy status is used instead.

In the second embodiment, multiple tuples can be determined by SF, and one tuple (e.g., one tuple including one sampling rate #1 and one sampling rate #2 and optionally one threshold) can be selected by UE or by gNB. In other words, the UE or the gNB can select the sampling rates.

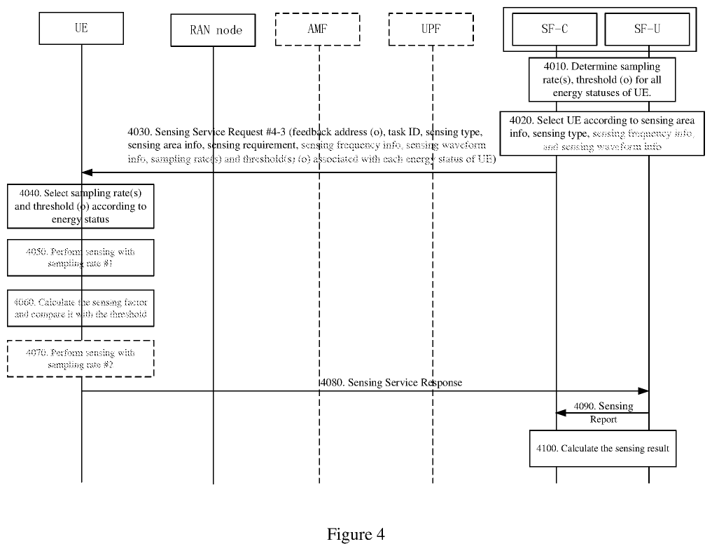

FIG. 4 illustrates a first sub-embodiment of the second embodiment, which relates to UE selecting the sampling rates in two-step sensing mechanism in UE based sensing. Steps 4010-4100 are an implementation of step 1080.

In step 4010, SF determines sampling rate #1(s) and sampling rate #2(s) and threshold(s) for all energy statuses of UE according to the sensing type and the sensing requirement. In a first implementation, SF determines multiple tuples, where each tuple is associated with one energy status of UE and includes sampling rate #1, sampling rate #2 and threshold. In a second implementation, SF determines multiple tuples, where each tuple is associated with one energy status of UE and includes sampling rate #1 and sampling rate #2, and one threshold that can be applied for all energy statuses of UE. In a third implementation, SF determines multiple tuples, where each tuple is associated with one energy status of UE and includes sampling rate #1 and sampling rate #2, while one threshold is predetermined for all energy statuses of UE.

In step 4020, SF selects UE according to at least the sensing area info, e.g., according to the sensing area info and optionally at least one of the sensing type, the sensing frequency info and the sensing waveform info. If the sensing frequency info and the sensing waveform info are not included in the sensing service request (e.g., sensing service request #3 in step 1050), SF determines the sensing frequency info and the sensing waveform info according to the sensing type. It is assumed that UE reports its sensing radius and optionally at least one of its sensing type, sensing frequency and sensing waveform when being registered to 5GC (e.g., to AMF). SF may obtain UE's location based on legacy positioning method. So, SF can determine UE's sensing area based on UE location and its sensing radius.

In step 4030, SF sends a sensing service request #4-3 to UE via AMF and RAN node. The sensing service request #4-3 includes task ID, sensing type, sensing area info, sensing requirement, sensing frequency info (optional), sensing waveform info (optional), sampling rate(s) and threshold(s) (optional) associated with each energy status of UE, and feedback address (optional) (e.g., IP address and optionally port number). As mentioned in step 4010, the sampling rate(s) and threshold(s) (optional) associated with each energy status of UE can be:
multiple tuples, where each tuple is associated with one energy status of UE and includes sampling rate #1, sampling rate #2 and threshold; or
multiple tuples, where each tuple is associated with one energy status of UE and includes sampling rate #1 and sampling rate #2, and one threshold that can be applied for all energy statuses of UE; or
multiple tuples, where each tuple is associated with one energy status of UE and includes sampling rate #1 and sampling rate #2 (in this condition, one threshold is predetermined for all energy statuses of UE).

If LMF and SF are co-located, LMF can obtain sensing result or raw sensing data from UE by reusing existing LTE Positioning Protocol (LPP) procedure.

For the loosely coupled architecture, SF can send the sensing service request #4-3 to UE via RAN node without AMF.

In step 4040, the UE, based on its own energy status, selects sampling rate #1, sampling rate #2, and the threshold (optional).

In step 4050, the UE performs sensing towards the given sensing area with selected sampling rate #1, the sensing frequency info, and the sensing waveform info. Incidentally, if the sensing frequency info and the sensing waveform info are not included in the sensing service request #4-3, they are determined by UE.

In step 4060, the UE calculates a sensing factor under the sampling rate #1 and compares the sensing factor with the threshold. For example, the sensing factor under sampling rate #1 can be a sensing SNR. If the sensing factor under the sampling rate #1 is lower than the threshold, it is determined that there is no sensing target in the sensing area, and step 4070 will not be performed. Otherwise (e.g., the sensing factor under the sampling rate #1 is equal to or higher than the threshold), step 4070 will be performed.

In step 4070, the UE performs sensing towards the given sensing area with sampling rate #2, the sensing frequency info and the sensing waveform info.

In step 4080, the UE sends a sensing service response to SF-U based on the feedback address. For example, UE sends the sensing service response to the RAN node, and the RAN node forwards the sensing service response to SF-U based on the feedback address. Alternatively, if the feedback address is not included in the sensing service request #4-3, UE sends the sensing service response to AMF via RAN node. And the AMF forwards the sensing service response further to SF based on the message type. For example, the AMF may determine, from the message type of the message (e.g., NAS message) carrying the sensing service response, and accordingly send the sensing service response to the origin of the sensing service request #4-3 (e.g., SF-C) while SF-C forwards the sensing service response to SF-U. If step 4070 is not performed, the sensing service response is no sensing target in the sensing area. If step 4070 is performed, the sensing service response is raw sensing data (e.g., raw sensing data that is received at step 4070 without further processing) or sensing result under sampling rate #2. For the loosely coupled architecture, UE can directly send the sensing service response to SF-U via RAN node without AMF.

In step 4090, SF-U informs SF-C that it has obtained the raw sensing data or sensing result under sampling rate #2 or no sensing target.

In step 4100, if a sensing result is required in the feedback type and UE feeds raw sensing data to SF-U, SF-C or SF-U calculates the sensing result (e.g., for a motion recognition task, the sensing result is the motion type) based on the raw sensing data under sampling rate #2 by using existing sensing algorithms, such pre-trained CNN model. If a sensing result is required in the feedback type and UE provides the sensing result to SF-U, SF provides the sensing result provided by UE directly to sensing consumer (e.g., AF). Otherwise (e.g., a sensing result is not required in the feedback type), there is no need to calculate the sensing result.

Incidentally, if there is only one integrated SF instead of SF-C and SF-U, steps 4090 and 4100 are performed internally within SF.

According to the first sub-embodiment of the second embodiment, SF determines sampling rate(s) and threshold(s) (optional) associated with each energy status (e.g., battery level or power mode) of UE, and provides the same to UE. The threshold, which is used for comparing with the sensing factor, may be the same for all energy statuses of UE, and is determined by SF or preconfigured. UE selects a pair of sampling rates (sampling rate #1 and sampling rate #2) and optionally the threshold based on its own energy status (e.g., battery level or power mode). When UE feedbacks the sensing service response, the selected pair of sampling rates or its energy status (e.g., battery level or power mode) may be piggybacked on the sensing service response.

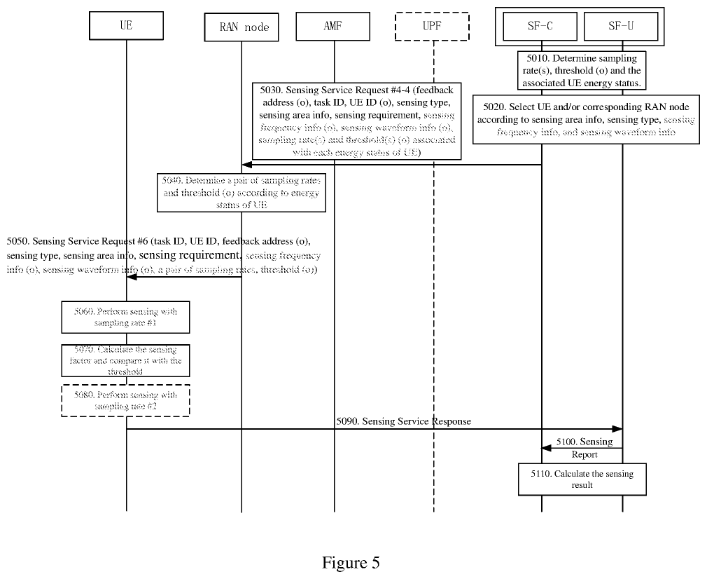

FIG. 5 illustrates a second sub-embodiment of the second embodiment, which relates to gNB selecting the sampling rates in two-step sensing mechanism in UE based sensing. Steps 5010-5110 are an implementation of step 1080.

In the first sub-embodiment of the second embodiment, UE is responsible to select the sampling rates (optionally as well as the threshold) according to its energy status. In the second sub-embodiment of the second embodiment, RAN node (e.g., gNB) is responsible to select the sampling rates (optionally as well as the threshold) according to energy status (e.g., battery level or power mode) of UE. It is assumed that each UE reports it power mode and/or battery level to RAN node directly. Alternatively, RAN node derives energy status of UE based on UE's overheating status. For example, if UE reports overheating, RAN node derives that UE is in low power mode or low battery level.

Step 5010 is the same as step 4010. That is, SF determines sampling rate #1(s) and sampling rate #2(s) and threshold(s) for all energy statuses of UE according to the sensing type and the sensing requirement.

Step 5020 may be the same as step 4020. That is, SF selects UE according to at least one of the sensing area info, the sensing type, the sensing frequency info and the sensing waveform info. In addition, the RAN node associated with the UE (e.g., the RAN node that serves the UE) is also determined.

Alternatively, in step 5020, SF selects RAN node according to at least the sensing area info, e.g., according to the sensing area info and optionally at least one of the sensing type, the sensing frequency info and the sensing waveform info (see step 1060). In this condition, UE will be selected by the RAN node selected by SF.

In step 5030, SF sends a sensing service request #4-4 to RAN node selected in step 5020 via AMF. The sensing service request #4-4 includes task ID, UE ID (if UE is selected in step 5020), sensing type, sensing area info, sensing requirement, sensing frequency info (optional), sensing waveform info (optional), sampling rate(s) and threshold(s) (optional) associated with each energy status of UE, and feedback address (optional) (e.g., IP address and optionally port number). For the loosely coupled architecture, SF can directly send the sensing service request #4-4 to RAN node without AMF.

In step 5040, RAN node selects a pair of sampling rates (i.e., sampling rate #1 and sampling rate #2) and the threshold (optional) based on UE's energy status. It is assumed that UE reports it power mode and/or battery level to RAN node directly. Alternatively, RAN node derives UE energy status based on UE's overheating status. If UE ID is not included in the sensing service request #4-4, RAN node first selects a UE according to at least the sensing area info, e.g., according to the sensing area info and optionally at least one of the sensing type, the sensing frequency info and the sensing waveform info.

In step 5050, RAN node sends a sensing service request #6 to UE. The sensing service request #6 includes task ID, UE ID, feedback address (optional), sensing type, sensing area info, sensing requirement, sensing frequency info (optional), sensing waveform info (optional), a pair of sampling rates (i.e., sampling rate #1 and sampling rate #2) and the threshold (optional).

Steps 5060 to 5110 are the same as steps 4050 to 4100 respectively. Detailed explanations of steps 5060 to 5110 are omitted.

In the above second embodiment, two sampling rates (i.e., sampling rate #1 and sampling rate #2) as well as the threshold are determined according to energy status of UE. A third embodiment relates to one sampling rate being determined according to energy status of UE in UE based sensing. It means that, in addition to two-step sensing, in a case of single sampling rate, the single sampling rate (i.e., one sampling rate) can be determined according to energy status of UE in UE based sensing.

In particular, SF may provide sampling rate and the associated given energy status (e.g., battery level or power mode). For example, a first sampling rate is configured for a first energy status; while a second sampling rate is configured for a second energy status. Generally, a high power mode (i.e., UE's remaining battery is high) supports high sampling rate, which is more power consumptive. For example, if the first power mode is higher than the second power mode, the first sampling rate can be higher than the second sampling rate. Optionally, a threshold can also be associated with each energy status. As a whole, SF may provide multiple tuples, where each tuple includes a sampling rate and optionally a threshold, associated with all energy statuses.

In particular, a method performed at an SF may comprise: receiving, from a first network node (e.g., AMF), a first sensing service request; and transmitting, to a second network node or a UE, a second sensing service request including at least multiple sampling rates each of which is associated with a different energy status.

When multiple tuples, where each tuple includes a sampling rate and optionally a threshold and is associated with a different energy status, are transmitted to the UE, the UE can select one tuple according to the UE's energy status. For example, the tuple including a sampling rate associated with an energy status that matches the UE's energy status is selected.

In particular, a method performed at a UE may comprise: receiving, from an SF, a sensing service request including at least multiple sampling rates each of which is associated with a different energy status; and determining one sampling rate from the multiple sampling rates according to the UE's energy status.

When multiple tuples, where each tuple includes a sampling rate and optionally a threshold and is associated with a different energy status, are transmitted to the RAN node, the RAN node can select a UE and determine one tuple according to the selected UE's energy status.

In particular, a method performed at a RAN node may comprise: receiving, from an SF, a sensing service request including at least multiple sampling rates each of which is associated with a different energy status; and determining one sampling rate from the multiple sampling rates according to selected UE's energy status.

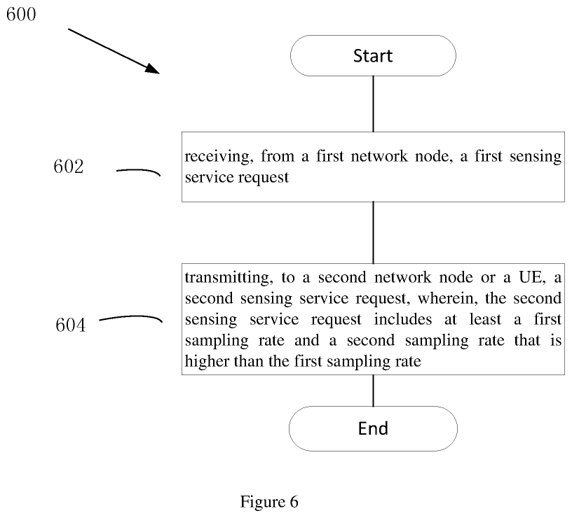

FIG. 6 is a schematic flow chart diagram illustrating an embodiment of a method 600 according to the present application. In some embodiments, the method 600 is performed by a network function such as an SF. In certain embodiments, the method 600 may be performed by a processor executing program code, for example, a microcontroller, a microprocessor, a CPU, a GPU, an auxiliary processing unit, a FPGA, or the like.

The method 600 may comprise: 602 receiving, from a first network node, a first sensing service request; and 604 transmitting, to a second network node or a UE, a second sensing service request, wherein, the second sensing service request includes at least a first sampling rate and a second sampling rate that is higher than the first sampling rate.

In some embodiment, if the second network node is a RAN node, the method further comprises selecting the RAN node according to at least sensing frequency information and sensing waveform information included in the first sensing service request. In some embodiment, the second sensing service request further includes a threshold, and the method further comprises receiving, from the selected RAN node, a sensing response, wherein, the sensing response is: no sensing target, or raw sensing data or sensing result based on the second sampling rate.

In some embodiment, if the second sensing service request is transmitted to the UE, the method further comprises determining multiple tuples, where each tuple is associated with one energy status of UE and includes at least the first sampling rate and the second sampling rate. In some embodiment, the method further comprises selecting the UE based on at least sensing area information included in the first sensing service request. In some embodiment, the method comprises transmitting, to the UE, the multiple tuples, and the method further comprises receiving, from the UE, a sensing response, wherein the sensing response is: no sensing target, or raw sensing data or sensing result based on the second sampling rate. In some embodiment, the method further comprises selecting a RAN node associated with the UE based on at least sensing area information included in the first sensing service request. In addition, the method comprises transmitting, to the selected RAN node, the multiple tuples, and the method further comprises receiving, from the UE selected by the selected RAN node, a sensing response, wherein the sensing response is: no sensing target, or raw sensing data or sensing result based on the second sampling rate.

In some embodiment, the method further comprises determining the first sampling rate and the second sampling rate according to sensing requirement included in the first sensing service request.

In some embodiment, the method further comprises determining sensing frequency and sensing waveform based on sensing type included in the first sensing service request.

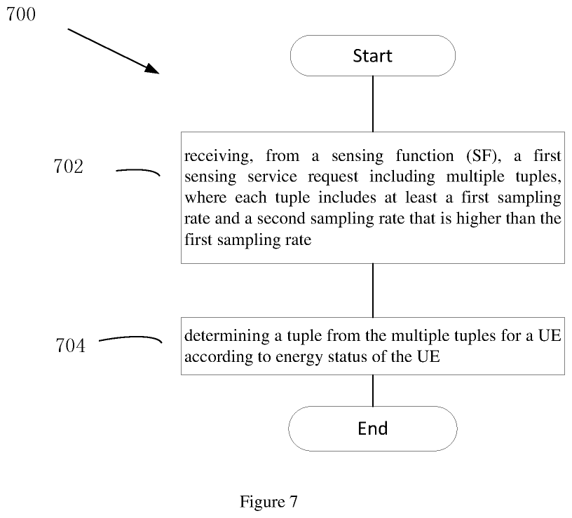

FIG. 7 is a schematic flow chart diagram illustrating an embodiment of a method 700 according to the present application. In some embodiments, the method 700 is performed by a network node such as a RAN node. In certain embodiments, the method 700 may be performed by a processor executing program code, for example, a microcontroller, a microprocessor, a CPU, a GPU, an auxiliary processing unit, a FPGA, or the like.

The method 700 may comprise 702 receiving, from a sensing function (SF), a first sensing service request including multiple tuples, where each tuple includes at least a first sampling rate and a second sampling rate that is higher than the first sampling rate; and 704 determining a tuple from the multiple tuples for a UE according to energy status of the UE.

In some embodiment, the method further comprises sending, to the UE, a second sensing service request including at least the determined tuple.

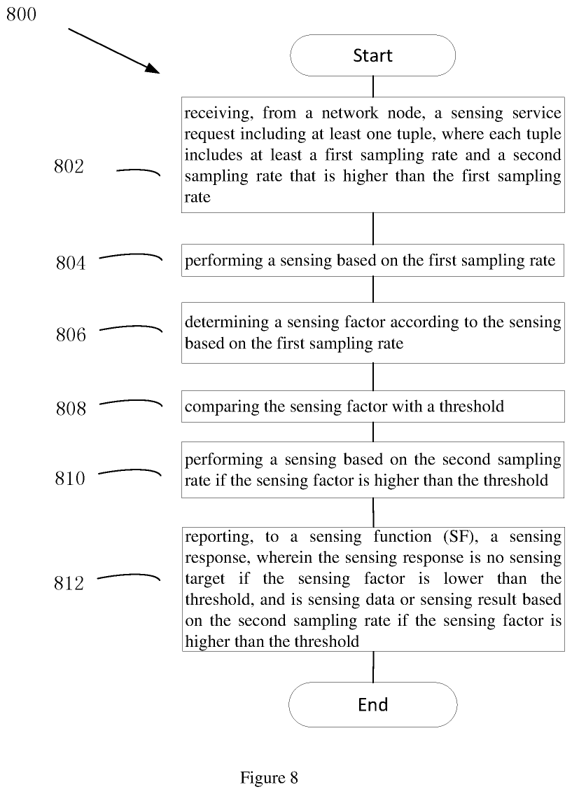

FIG. 8 is a schematic flow chart diagram illustrating an embodiment of a method 800 according to the present application. In some embodiments, the method 800 is performed by an apparatus, such as a remote unit (e.g., UE). In certain embodiments, the method 800 may be performed by a processor executing program code, for example, a microcontroller, a microprocessor, a CPU, a GPU, an auxiliary processing unit, a FPGA, or the like.

The method 800 may comprise 802 receiving, from a network node, a sensing service request including at least one tuple, where each tuple includes at least a first sampling rate and a second sampling rate that is higher than the first sampling rate; 804 performing a sensing based on the first sampling rate; 806 determining a sensing factor according to the sensing based on the first sampling rate; 808 comparing the sensing factor with a threshold; 810 performing a sensing based on the second sampling rate if the sensing factor is higher than the threshold; and 812 reporting, to a sensing function (SF), a sensing response, wherein the sensing response is no sensing target if the sensing factor is lower than the threshold, and is sensing data or sensing result based on the second sampling rate if the sensing factor is higher than the threshold.

In some embodiment, the first sensing service request includes one tuple including at least the first sampling rate and the second sampling rate.

In some embodiment, the first sensing service request includes multiple tuples each including at least the first sampling rate and the second sampling rate associated with an energy status of UE, and the method further comprises selecting one tuple from the multiple tuples according to energy status of the UE.

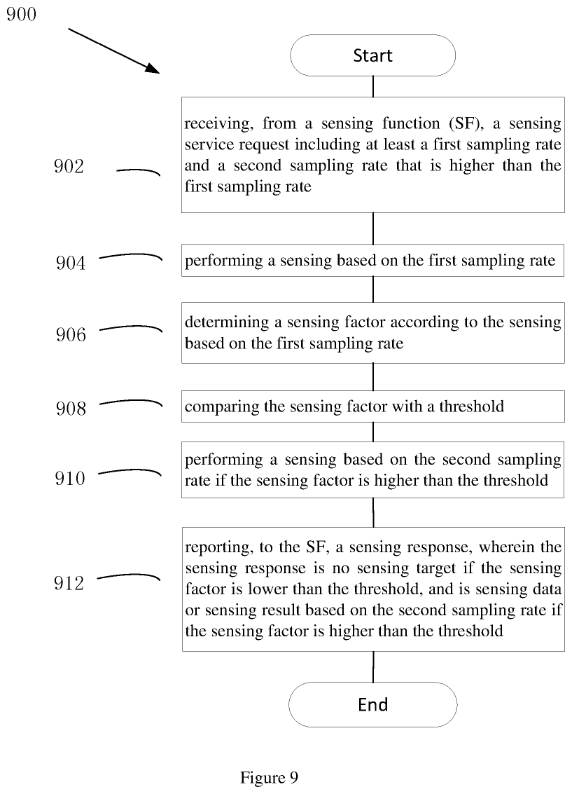

FIG. 9 is a schematic flow chart diagram illustrating an embodiment of a method 900 according to the present application. In some embodiments, the method 900 is performed by a network node such as a RAN node. In certain embodiments, the method 900 may be performed by a processor executing program code, for example, a microcontroller, a microprocessor, a CPU, a GPU, an auxiliary processing unit, a FPGA, or the like.

The method 900 may comprise 902 receiving, from a sensing function (SF), a sensing service request including at least a first sampling rate and a second sampling rate that is higher than the first sampling rate; 904 performing a sensing based on the first sampling rate; 906 determining a sensing factor according to the sensing based on the first sampling rate; 908 comparing the sensing factor with a threshold; 910 performing a sensing based on the second sampling rate if the sensing factor is higher than the threshold; and 912 reporting, to the SF, a sensing response, wherein the sensing response is no sensing target if the sensing factor is lower than the threshold, and is sensing data or sensing result based on the second sampling rate if the sensing factor is higher than the threshold.

In some embodiment, the first sensing service request further includes sensing frequency information and sensing waveform information, and the method comprises performing the sensing based on the sensing frequency information and the sensing waveform information.

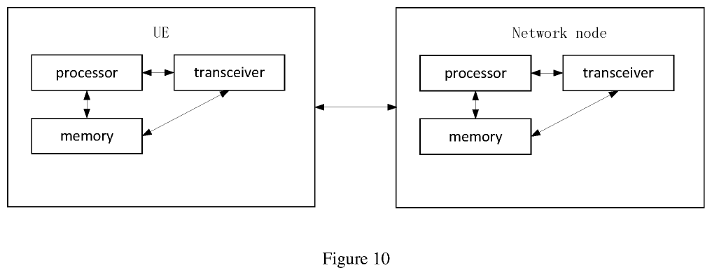

FIG. 10 is a schematic block diagram illustrating apparatuses according to one embodiment.

The network function or network node or network entity (e.g., SF or RAN node) includes a processor, a memory, and a transceiver. The processor implements a function, a process, and/or a method which are proposed in FIG. 6 or 7 or 9.

SF comprises a processor and a transceiver coupled to the processor, wherein the processor is configured to receive, from a first network node, via the transceiver, a first sensing service request; and transmit, to a second network node or a UE, via the transceiver, a second sensing service request, wherein, the second sensing service request includes at least a first sampling rate and a second sampling rate that is higher than the first sampling rate.

In some embodiment, if the second network node is a RAN node, the processor is further configured to select the RAN node according to at least sensing frequency information and sensing waveform information included in the first sensing service request. In some embodiment, the second sensing service request further includes a threshold, and the processor is further configured to receive, from the selected RAN node, via the transceiver, a sensing response, wherein, the sensing response is: no sensing target, or raw sensing data or sensing result based on the second sampling rate.

In some embodiment, if the second sensing service request is transmitted to the UE, the processor is further configured to determine multiple tuples, where each tuple is associated with one energy status of UE and includes at least the first sampling rate and the second sampling rate. In some embodiment, the processor is further configured to select the UE based on at least sensing area information included in the first sensing service request. In some embodiment, the processor is configured to transmit, to the UE, via the transceiver, the multiple tuples, and the processor is further configured to receive, from the UE, via the transceiver, a sensing response, wherein the sensing response is: no sensing target, or raw sensing data or sensing result based on the second sampling rate. In some embodiment, the processor is further configured to select a RAN node associated with the UE based on at least sensing area information included in the first sensing service request. In addition, the processor is configured to transmit, to the selected RAN node, via the transceiver, the multiple tuples, and the processor is further configured to receive, from the UE selected by the selected RAN node, via the transceiver, a sensing response, wherein the sensing response is: no sensing target, or raw sensing data or sensing result based on the second sampling rate.

In some embodiment, the processor is further configured to determine the first sampling rate and the second sampling rate according to sensing requirement included in the first sensing service request.

In some embodiment, the processor is further configured to determine sensing frequency and sensing waveform based on sensing type included in the first sensing service request.

A first RAN node comprises a processor and a transceiver coupled to the processor, wherein the processor is configured to receive, from a sensing function (SF), via the transceiver, a first sensing service request including multiple tuples, where each tuple includes at least a first sampling rate and a second sampling rate that is higher than the first sampling rate; and determine a tuple from the multiple tuples for a UE according to energy status of the UE.

In some embodiment, the processor is further configured to send, to the UE, via the transceiver, a second sensing service request including at least the determined tuple.

A second RAN node comprises a processor and a transceiver coupled to the processor, wherein the processor is configured to receive, from SF, via the transceiver, a sensing service request including at least a first sampling rate and a second sampling rate that is higher than the first sampling rate; perform a sensing based on the first sampling rate; determine a sensing factor according to the sensing based on the first sampling rate; compare the sensing factor with a threshold; perform a sensing based on the second sampling rate if the sensing factor is higher than the threshold; and report, to SF, via the transceiver, a sensing response, wherein the sensing response is no sensing target if the sensing factor is lower than the threshold, and is sensing data based on the second sampling rate if the sensing factor is higher than the threshold.

In some embodiment, the sensing service request further includes sensing frequency information and sensing waveform information, and the processor is configured to perform the sensing based on the sensing frequency information and the sensing waveform information.

The UE (i.e., the remote unit) includes a processor, a memory, and a transceiver. The processor implements a function, a process, and/or a method which are proposed in FIG. 8.

The UE comprises a transceiver; and a processor coupled to the transceiver, wherein the processor is configured to receive, from a network node, via the transceiver, a sensing service request including at least one tuple, where each tuple includes at least a first sampling rate and a second sampling rate that is higher than the first sampling rate; perform a sensing based on the first sampling rate; determine a sensing factor according to the sensing based on the first sampling rate; compare the sensing factor with a threshold; perform a sensing based on the second sampling rate if the sensing factor is higher than the threshold; and report, to a sensing function (SF), via the transceiver, a sensing response, wherein the sensing response is no sensing target if the sensing factor is lower than the threshold, and is sensing data or sensing result based on the second sampling rate if the sensing factor is higher than the threshold.

In some embodiment, the first sensing service request includes one tuple including at least the first sampling rate and the second sampling rate.

In some embodiment, the first sensing service request includes multiple tuples each including at least the first sampling rate and the second sampling rate associated with an energy status of UE, and the processor is further configured to select one tuple from the multiple tuples according to energy status of the UE.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A sensing function (SF) of a network architecture, comprising:
at least one memory; and
at least one processor coupled with the at least one memory and configured to cause the SF to:
receive, from a first network node, a first sensing service request; and
transmit, to a second network node or a user equipment (UE), a second sensing service request, wherein the second sensing service request includes at least a first sampling rate and a second sampling rate that is higher than the first sampling rate.

2. The SF of claim 1, wherein, if the second network node is a RAN node, the at least one processor is configured to cause the SF to select the RAN node according to at least sensing frequency information and sensing waveform information included in the first sensing service request.

3. The SF of claim 2, wherein,
the second sensing service request further includes a threshold, and
the at least one processor is configured to cause the SF to receive, from the selected RAN node, a sensing response, wherein the sensing response is:
no sensing target, or
raw sensing data or sensing result based on the second sampling rate.

4. The SF of claim 1, wherein, if the second sensing service request is transmitted to the UE, the at least one processor is configured to cause the SF to determine multiple tuples, wherein each tuple is associated with one energy status of UE and includes at least the first sampling rate and the second sampling rate.

5. The SF of claim 4, wherein the at least one processor is configured to cause the SF to select the UE based on at least sensing area information included in the first sensing service request.

6. The SF of claim 4, wherein,
the at least one processor is configured to cause the SF to transmit, to the UE, the multiple tuples, and
the at least one processor is further configured to cause the SF to receive, from the UE, a sensing response, wherein the sensing response is:
no sensing target, or
raw sensing data or sensing result based on the second sampling rate.

7. The SF of claim 4, wherein the at least one processor is configured to cause the SF to select a RAN node associated with the UE based on at least sensing area information included in the first sensing service request.

8. The SF of claim 7, wherein,
the at least one processor is configured to cause the SF to transmit, to the selected RAN node, the multiple tuples, and
the at least one processor is configured to cause the SF to receive, from the UE selected by the selected RAN node, a sensing response, wherein the sensing response is: no sensing target, or raw sensing data or sensing result based on the second sampling rate.

9. The SF of claim 1, wherein the at least one processor is further configured to cause the SF to determine the first sampling rate and the second sampling rate according to sensing requirement included in the first sensing service request.

10. The SF of claim 1, wherein the at least one processor is configured to cause the SF to determine sensing frequency and sensing waveform based on sensing type included in the first sensing service request.

11. A radio access node (RAN) node of a network architecture, the RAN node comprising:
at least one memory; and
at least one processor coupled with the at least one memory and configured to cause the RAN node to:
receive, from a sensing function (SF), a first sensing service request including multiple tuples, wherein each tuple includes at least a first sampling rate and a second sampling rate that is higher than the first sampling rate; and
determine a tuple from the multiple tuples for a UE according to energy status of the UE.

12. The RAN node of claim 11, wherein the at least one processor is configured to cause the RAN node to send, to the UE, a second sensing service request including at least the determined tuple.

13. A user equipment (UE), comprising:
at least one memory; and
at least one processor coupled with the at least one memory and configured to cause the UE to:
receive, from a network node, a sensing service request including at least one tuple, where each tuple includes at least a first sampling rate and a second sampling rate that is higher than the first sampling rate;
perform a sensing based on the first sampling rate;
determine a sensing factor according to the sensing based on the first sampling rate;
compare the sensing factor with a threshold;
perform a sensing based on the second sampling rate if the sensing factor is higher than the threshold; and
report, to a sensing function (SF), a sensing response, wherein the sensing response is no sensing target if the sensing factor is lower than the threshold, and is sensing data or sensing result based on the second sampling rate if the sensing factor is higher than the threshold.

14. The UE of claim 13, wherein the first sensing service request includes one tuple including at least the first sampling rate and the second sampling rate.

15. The UE of claim 13, wherein,
the first sensing service request includes multiple tuples each including at least the first sampling rate and the second sampling rate associated with an energy status of UE, and
the at least one processor is configured to cause the UE to select one tuple from the multiple tuples according to energy status of the UE.

16. A method performed by a sensing function (SF) of a network architecture, the method comprising:
receiving, from a first network node, a first sensing service request; and
transmitting, to a second network node or a user equipment (UE), a second sensing service request, wherein the second sensing service request includes at least a first sampling rate and a second sampling rate that is higher than the first sampling rate.

17. The method of claim 16, further comprising, if the second network node is a RAN node, selecting the RAN node according to at least sensing frequency information and sensing waveform information included in the first sensing service request.

18. The method of claim 17, wherein,
the second sensing service request further includes a threshold, and the method further comprising receiving, from the selected RAN node, a sensing response, wherein the sensing response is:
no sensing target, or
raw sensing data or sensing result based on the second sampling rate.

19. The method of claim 16, further comprising, if the second sensing service request is transmitted to the UE, determining multiple tuples, wherein each tuple is associated with one energy status of UE and includes at least the first sampling rate and the second sampling rate.

20. The method of claim 19, further comprising selecting the UE based on at least sensing area information included in the first sensing service request.
